(19) United States
(12) Patent Application Publication
(10) Pub. No.: US 2009/0205586 A1
(43) Pub. Date: Aug. 20, 2009

(54) Dog garment

(75) Inventor: Thomas B.J. Matthews, Memphis, TN (US)

Correspondence Address: RUSSELL H. WALKER;WALKER, McKENZIE & WALKER, P.C., 6363 POPLAR AVE., Suite 318, MEMPHIS, TN, 38119-4899, US

(73) Assignee: Avery Outdoors, Inc., Memphis, TN (US)

(21) Appl. No.: 12/070,148

(22) Filed: Feb. 15, 2008

(51) Int. Cl. A01K 29/00; B65G 9/00

(52) U.S. Cl. 119/843; 119/863

(57) ABSTRACT

A garment for the trunk of a dog. The garment includes a body member for covering the trunk of the dog, and a handle that does not extend above the outer surface of the body member to allow the body member, and dog, to be grasped and lifted.

### BACKGROUND OF THE INVENTION

1. Field of the Invention

The present invention relates, in general, to a garment (e.g., a vest or jacket) for being worn by a dog, and in particular, to such a garment especially adapted for use in lifting a dog into a boat or the like.

2. Background Art

It is often desired to cover the trunk or torso of a dog, especially hunting dogs used to retrieve waterfowl or the like from water. A preliminary patentability search in Class D30, subclass 145; Class 54, subclass 79.1; and Class 119, subclass 850 produced the following documents, which appear to be relevant to the present invention:

Rominger, U.S. Pat. No. D510,160, issued Sep. 27, 2005, for a pet floatation vest having strap-like handles that extend upward from the top thereof.

Trepanier, U.S. Patent Application Publication US 2004/0031448, published Feb. 19, 2004, for a post-surgical care pet bandage cover.

Newman, U.S. Patent Application Publication US 2003/0177984, published Sep. 25, 2003, for an animal vest having various elongated wights or elongated buoyancy members removably attached to the exterior surface thereof. A D-ring is also attached to the exterior surface to which a leash may be attached.

Hibbert, U.S. Pat. No. 6,595,162, issued Jul. 22, 2003, for an animal cover having a plurality of straps extending upward therefrom.

Brezinski, U.S. Pat. No. 6,584,939, issued Jul. 1, 2003, for an animal coat having an access opening to permit attachment of a leash or other device to the animal's collar.

Hibbert, U.S. Pat. No. 6,431,123, issued Aug. 13, 2002, for an animal protective cover having a pair of handles extending upward therefrom.

Ishihara, U.S. Pat. No. D453,594, issued Feb. 12, 2002, for a pet harness having a strap extending upward therefrom.

Slater, U.S. Pat. No. 6,123,049, issued Sep. 26, 2000, for a bullet proof canine vest having a harness composed of a plurality of straps mounted on the exterior surface thereof.

Balzarini, U.S. Pat. No. D427,734, issued Jul. 4, 2000, for an animal garment.

Caditz, U.S. Pat. No. 5,996,537, issued Dec. 7, 1999, for a canine coat.

Caditz, U.S. Pat. No. D379,686, issued Jun. 3, 1997, for a canine chest and belly protector.

Collins, U.S. Pat. No. 4,530,309, issued Jul. 23, 1985, for an animal support harness having pair of loop handles extending upward therefrom.

Zielinski, U.S. Pat. No. 4,355,600, issued Oct. 26, 1982, discloses a protective body suit for animals.

Hafner, U.S. Pat. No. 2,273,706, issued Feb. 17, 1942, for an animal garment.

Griffiths, U.S. Pat. No. 1,595,834, issued Aug. 10, 1926, for a dog sweater having an opening in the top for allowing attachment therethrough to the dogs harness.

None of these references, either singly or in combination, disclose or suggest the present invention.

### BRIEF SUMMARY OF THE INVENTION

The present invention provides a garment including a body member for covering the trunk of a dog, and a handle that does not extend above the outer surface of the body member to allow the body member to be grasped and lifted without the danger of becoming tangled or snagged on brush or other obstacles, etc.

It is an object of the present invention to provide a garment for covering the trunk of a dog to provide warmth and protection, etc., to the trunk of the dog especially during activities such as hunting, etc.

It is another object of the present invention to provide such a garment that includes a handle for allowing the dog to be easily lifted into a boat, stand, etc., with the handle especially designed so that it does not pose a danger of becoming tangled or snagged on brush or other obstacles, etc.

It is another object of the present invention to provide such a garment that includes internal reinforcing for strengthening the body member and preventing the handle from ripping out during use.

### BRIEF DESCRIPTION OF THE SEVERAL VIEWS OF THE DRAWINGS

FIG. 1 is a side elevational view of the garment of the present invention, shown covering the trunk of a dog.

FIG. 2 is a side elevational view of the garment of the present invention, but with the garment and dog being lifted.

FIG. 3 is a bottom plan view of the garment of the present invention, shown in a fully spread-opened position.

FIG. 4 is a sectional view as taken on line 4-4 of FIG. 3.

FIG. 5 is a sectional view as taken on line 5-5 of FIG. 3.

FIG. 6 is a sectional view substantially as taken on line 6-6 of FIG. 1 with the dog omitted.

FIG. 7 is a sectional view substantially as taken on line 7-7 of FIG. 2 with the dog omitted.

### DETAILED DESCRIPTION OF THE INVENTION

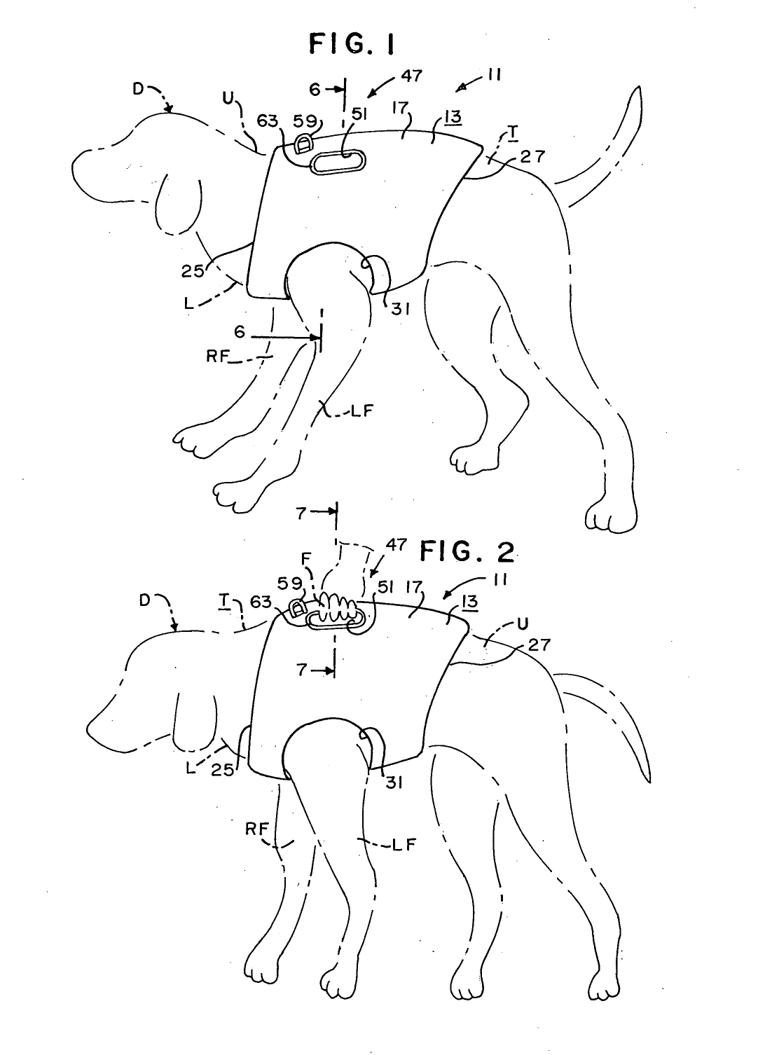

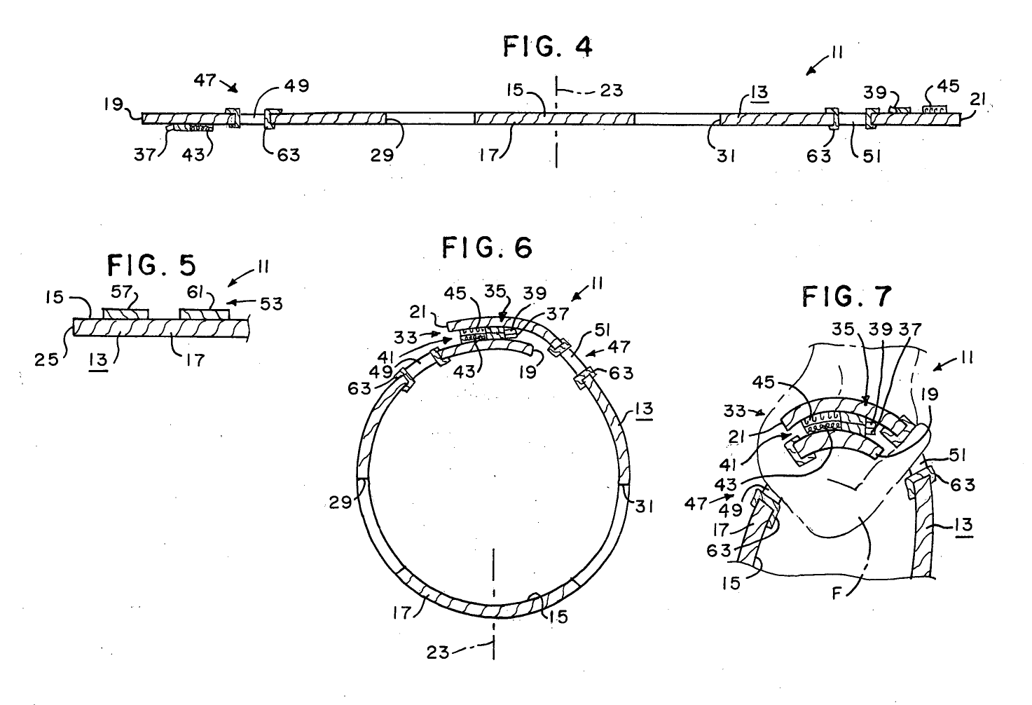

A preferred embodiment of the garment of the present invention is shown in FIGS. 1-7, and identified by the numeral 11. The garment 11 is preferably used to cover for the torso or trunk T of a dog D or the like with a back, dorsal or upper side U and a stomach, ventral or lower side L. The dog D typically has a right front leg RF and a left front leg LF. The garment 11 is especially for use in combination with a hunting dog used to retrieve waterfowl or the like from water to provide warmth and protection to the torso T of the dog D without increasing the chances that the dog D and/or garment 11 will become snagged or tangled on brush, etc., and while allowing the dog D and garment 11 to be easily lifted as a unit into a boat, stand, blind, etc., without danger of tearing or ripping the garment 11.

The garment 11 includes a body member 13 for covering the torso T of the dog D.

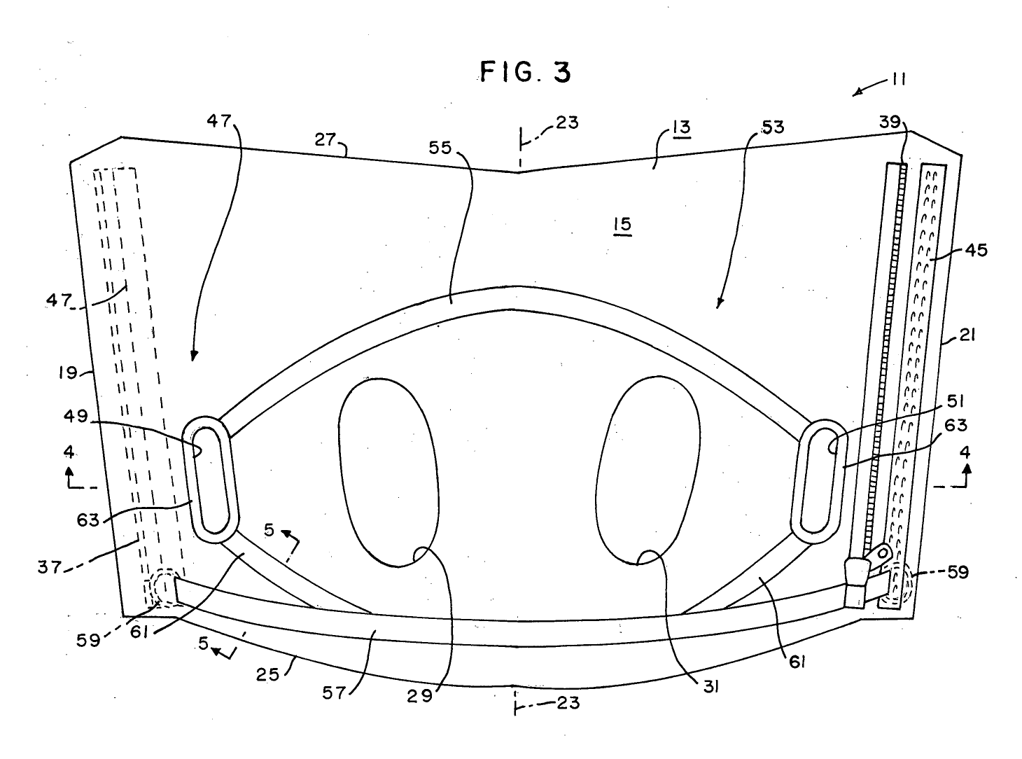

The body member 13 has an inner surface 15 and an outer surface 17. The body member 13 preferably has a first edge 19 and a second edge 21, a midline 23 between the first and second edges 19, 21 for positioning beneath the trunk T of the dog D. The body member 13 is preferably designed to extend around the torso T of the dog D and preferably has a front end 25, a rear end 27, a right front leg opening 29 for receiving the right front leg RF of the dog D, and a left front leg opening 31 for receiving the left front leg LF of the dog D. The body member 13 may be made in various manners, out of various materials, and in various specific sizes and designs to fit various size and breed of dogs for use in various activities and in various terrain and weather conditions, etc. For example, the body member 13 may be cut and sewn from a flexible synthetic rubber sheet such as a flexible Neoprene foam sheet, etc., in the planar shape generally shown in FIG. 3. The outer surface 17 of the body member 13 may have a typical camouflaged pattern or finish, etc., as will now be apparent to those skilled in the art.

The garment 11 preferably includes a fastener 33 (see, in general, FIGS. 6 and 7) for fastening the first and second edges 19, 21 of the body member 13 to one another. The fastener 33 preferably includes a zipper 35 for zipping the first and second edges 19, 21 of the body member 13 to one another. The zipper 35 may include a first part 37 attached to the first edge 19 of the body member 13, and a second part 39 attached to the second edge 21 of the body member 13 for coacting with the first part 37 in a typical manner well know to those skilled in the art to allow the body member 13 to be quickly zipped about and unzipped from the torso T of the dog D. The fastener 33 may also include well known Velcro-type hook-and-loop fastening means 41 for fastening the first and second edges 19, 21 of the body member 13 to one another. The hook-and-loop fastening means 41 may include a first part 43 attached to the first edge 19 of the body member 13, and a second part 45 attached to the second edge 21 of the body member 13 for coacting with the first part 43 in a typical manner well know to those skilled in the art to allow the body member 13 to be quickly attached about and removed from the torso T of the dog D. As shown in FIGS. 6 and 7, the hook-and-loop fastening means 41 may be used to form a flap over the zipper 35 to help prevent rain or weather intrusion to the zipper 35 in a manner as will be apparent to those skilled in the art.

The garment 11 includes a handle 47 coupled to said body member 13 and not extending above the outer surface 17 of the body member 13. The handle 47 preferably has or consist of one or more openings extending through the body member 13 between the inner and outer surfaces 15, 17 of the body member. More specifically, the handle 47 preferably has a first handle opening 49 extending through the body member 13 between the inner and outer surfaces 15, 17 thereof, and preferably has a second handle opening 51 extending through the body member 13 between the inner and outer surfaces 15, 17 thereof. As clearly shown in FIGS. 6 and 7, the first and second handle openings 49, 51 are preferably located adjacent one another when the first and second edges 19, 21 of the body member 13 are fastened to one another to allow a person to grasp the body member 13 by extending fingers F into one of the handle openings 49, 51 and out of the other of the handle openings 49, 51.

The garment 11 preferably includes reinforcing means 53 attached to the body member 13 for strengthening the body member 13 and to prevent the handle 47 from tearing or ripping out, etc. The reinforcing means 53 preferably includes webbing attached to the body member 13, preferably to the inner surface 15 of the body member 13. More specifically, as clearly shown in FIG. 3, the reinforcing means 53 preferably includes first reinforcing webbing 55 attached to inner surface 15 of the body member 13 (i.e., internal of the body member 13 when attached to the dog D to reduce the danger of snagging, etc.) and extending between the first and second handle openings 49, 51 and across the midline 23 of the body member 13, between the leg openings 29, 31 and said rear end 27 of the body member 13. In addition, as also clearly shown in FIG. 3, the reinforcing means 53 preferably includes second reinforcing webbing 57 attached to inner surface 15 of the body member 13 (i.e., internal of the body member 13 when attached to the dog D to reduce the danger of snagging, etc.) and extending between the first and second handle openings 49, 51 and across the midline 23 of the body member 13, a spaced distance from the first reinforcing webbing and preferably between the leg openings 29, 31 and the front end 25 of the body member 13. The second reinforcing webbing 57 may extend fully between the first and second parts 43, 45 of the hook-and-loop fastening mean 41 and may have opposite ends that extend through the body member 13 and terminate with typical D-rings 59 on the outer surface 17 of the body member 13 to allow a lead or the like to be attached to the dog D thereby as will now be apparent to those skilled in the art. When the garment 11 is fastened about the torso T of the dog D, the first and second reinforcing webbing 55, 57 will extend under the torso T of the dog D to strengthen the body member 13, especially when the dog D is lifted using the handle 47, etc., and prevent or hinder the handle openings 49, 51 from ripping or tearing out as the dog D is lifted. As clearly shown in FIG. 3, the reinforcing means 53 may also include connecting webbing 61 extending between each handle opening 49, 51 and the second reinforcing webbing 57. Further, the reinforcing means 53 may include reinforcing webbing 63 or the like attached to and extending around each handle opening 49, 51 to further strengthen each handle opening 49, 51 as will now be apparent to those skilled in the art. The various webbing 55, 57, 61, 63 may be typical nylon or cotton straps or the like sewn or otherwise attached to the body member 13 as will now be apparent to those skilled in the art.

Pockets (not shown) for holding floatation material or the like (not shown) may be attached to the body 13 as is well known in the prior art and as will now be apparent to those skilled in the art.

To use the garment 11, with the fastener 33 unfastened and the body member 13 spread open, the right and left front legs RF, LF of the dog D are inserted through the respective right and left front leg openings 29, 31 of the body member 13, and the first and second edges 19, 21 brought over the back or upper side U of the dog D and attached together using the zipper 35 and/or hook-and-loop fastening means 41. The dog D is then ready for “work” and can be easily lifted into a boat or the like using the handle openings 49, 51 as shown in FIG. 7, with the reinforcing means 53 preventing the handle openings 49, 51 form ripping out, etc., and with the unique design and construction of the handle 47 serving to prevent the garment 11 from being snagged or tangled, etc., as the dog D is “working” to retrieve objects, etc.

Although the present invention has been described and illustrated with respect to a preferred embodiment and a preferred use therefor, it is not to be so limited since modifications and changes can be made therein which are within the full intended scope of the invention.

1. A garment for the trunk of a dog; said garment comprising:
(a) a body member for covering the trunk of the dog, said body member having an inner surface and an outer surface; and
(b) a handle coupled to said body member and not extending above said outer surface of said body member.

2. The garment of claim 1 in which body member has a first edge and a second edge; and in which is included a fastener for fastening said first and second edges of said body member to one another.

3. The garment of claim 1 in which is included reinforcing means attached to said body member for strengthening said body member.

4. The garment of claim 3 in which said reinforcing means includes webbing attached to said body member.

5. The garment of claim 4 in which said webbing is attached to said inner surface of said body member.

6. The garment of claim 1 in which said handle has an opening extending through said body member between said inner and outer surfaces of said body member.

7. The garment of claim 1 in which said handle has a first handle opening extending through said body member between said inner and outer surfaces of said body member, and has a second handle opening extending through said body member between said inner and outer surfaces of said body member.

8. The garment of claim 7 in which said first and second handle openings are located adjacent one another to allow a person to grasp said body member by extending fingers into one of said handle openings and out of the other of said handle openings.

9. The garment of claim 8 in which said body member has first and second edges, and has a midline between said first and second edges for positioning beneath the trunk of the dog; in which is included reinforcing means attached to said body member for strengthening said body member; and in which said reinforcing means includes webbing attached to said body member and extending between from said first and second handle openings and across said midline of said body member.

10. The garment of claim 8 in which said body member has first and second edges, and has a midline between said first and second edges for positioning beneath the trunk of the dog; in which is included reinforcing means attached to said body member for strengthening said body member; in which said reinforcing means includes first reinforcing webbing attached to said body member and extending between said first and second handle openings and across said midline of said body member; and in which said reinforcing means includes second reinforcing webbing attached to said body member and extending between said first and second handle openings a spaced distance from said first reinforcing webbing and extending between said first and second edges of said body member and across said midline of said body member.

11. The garment of claim 2 in which said fastener includes a zipper for zipping said first and second edges of said body member to one another.

12. The garment of claim 2 in which said fastener includes hook and loop fastening means for fastening said first and second edges of said body member to one another.

13. The garment of claim 2 in which said fastener includes a zipper for zipping said first and second edges of said body member to one another, and includes hook and loop fastening means for fastening said first and second edges of said body member to one another.

14. In combination with a dog having a torso with a dorsal side and a ventral side; a garment covering the torso of the dog, the dog having a right front leg and a left front leg; said garment comprising:
(a) a body member extending around the torso of the dog, said body member having a right front leg opening receiving the right front leg of the dog and having a left front leg opening receiving the left front leg of the dog; said body member having a front end and a rear end, having a first edge and a second edge, and having an inner surface and an outer surface;
(b) securing means securing said first and second edges of said body member to one another;
(c) a handle coupled to said body member and not extending above said outer surface of said body member; said handle having a first handle opening extending through said body member between said inner and outer surfaces of said body member, and having a second handle opening extending through said body member between said inner and outer surfaces of said body member and located adjacent said first handle opening to allow a person to grasp said body member by extending fingers into one of said handle openings and out of the other of said handle openings; and
(d) reinforcing means attached to said inner surface of said body member extending under the torso of the dog for strengthening said body member.

15. The combination of claim 14 in which said reinforcing means includes a reinforcing web extending between said first and second handle openings beneath the torso of the dog between said leg openings and said rear end of said body member.

16. The combination of claim 15 in which said reinforcing means includes a second reinforcing web extending between said first and second handle openings beneath the torso of the dog between said leg openings and said front end of said body member.
